(19) United States
(12) Patent Application Publication
(10) Pub. No.: US 2009/0040760 A1
(43) Pub. Date: Feb. 12, 2009

(54) ILLUMINATION DEVICE HAVING UNIDIRECTIONAL HEAT-DISSIPATING ROUTE

(76) Inventors: Kuo-Hsin CHEN, Taipei (TW); Hsuan-Chih Lin, Taipei (TW)

Correspondence Address: HDSL, P.O. BOX 220746, CHANTILLY, VA, 20153-0746, US

(21) Appl. No.: 12/187,772

(22) Filed: Aug. 7, 2008

(30) Foreign Application Priority Data
Aug. 10, 2007 (TW) 096129526

(51) Int. Cl. F21V 29/02; F21V 21/00

(52) U.S. Cl. 362/249; 362/373

(57) ABSTRACT

An illumination device having an unidirectional heat-dissipating route, includes a heat sink and a LED light module. The heat sink includes a heat plate, a heat pipe and a heat-dissipating body. The heat pipe has a heat absorbing portion and a heat dissipating portion with a horizontal position different to that of the heat absorbing portion. The heat absorbing portion is connected to the heat plate, and a plurality of grooves is formed in the heat pipe to be communicated with the heat absorbing portion and the heat dissipating portion. The heat absorbing portion is lower than the heat dissipating portion. The heat-dissipating body is connected to the heat dissipating portion. The LED light module is connected to the heat plate. Thus the LEDs are protected and prevented from being destroyed by the heat, and the working life thereof is increased greatly.

### BACKGROUND

1. Field of the Invention

The present invention relates to an illumination device, and more particularly, to an illumination device suitable in the high temperature environment.

2. Description of the Related Art

LED (light emitting diode) has many advantages, such as excellent luminance, long life, lower power-consumption, etc, such that it has been used widely in indoor or outdoor illumination devices. However, the LED should be operated in a suitable temperature working-environment, which relates directly to the working-life of the LED. Therefore, the present invention is to focus on the heat-dissipating capability of the illumination device.

A conventional illumination device, as disclosed in the Taiwan Patent No. M309053, forms an insulating layer and a printed circuit on a bottom surface of a metal substrate for being electrically connected to a plurality of LEDs. The LED illumination device is designed that heat absorbing portions of heat pipes are connected to a top surface of the metal substrate, and heat dissipating portions of the heat pipes are extended and connected to a heat-dissipating element. The heat-dissipating element is arranged in an open defined in an end of a light pole to contact the inner surface of the light pole for dissipating the heat.

In the conventional illumination device, the heat absorbing portions and the heat dissipating portions of the heat pipes are arranged in a same horizontal position. If the sunlight irradiates directly on the light pole, the heat will be transmitted through the heat-dissipating element, the heat dissipating portions of the heat pipes, the heat absorbing portions of the heat pipes and the metal substrate in series, and finally be transmitted to the LEDs. Therefore, the LEDs are heated to be generally in the high temperature environment, such that the working life of the LEDs are decreased greatly.

### BRIEF SUMMARY

An illumination device having an unidirectional heat-dissipating route, in accordance with an exemplary embodiment of the present invention, includes a heat sink and a LED light module. The heat sink includes a heat plate, a heat pipe and a heat-dissipating body. The heat pipe has a heat absorbing portion and a heat dissipating portion with a horizontal position different to that of the heat absorbing portion. The heat absorbing portion is connected to the heat plate, and a plurality of grooves is formed in the heat pipe to be communicated with the heat absorbing portion and the heat dissipating portion. The heat absorbing portion is lower than the heat dissipating portion. The heat-dissipating body is connected to the heat dissipating portion. The LED light module is connected to the heat plate.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric exploded view of a heat sink and a LED light module of an illumination device, in accordance with an exemplary embodiment of the present invention.

FIG. 2 is an isometric assembled view of the heat sink and the LED light module of the illumination device of the present invention.

FIG. 3 is an assembled cross-sectional view of the illumination device of the present invention.

FIG. 4 is a partial-enlarged view of region A as shown in FIG. 3.

FIG. 5 is an using-state cross-sectional view of the illumination device of the present invention.

### DETAILED DESCRIPTION

Reference will now be made to the drawings to describe exemplary embodiments of the present illumination device, in detail. The following description is given by way of example, and not limitation.

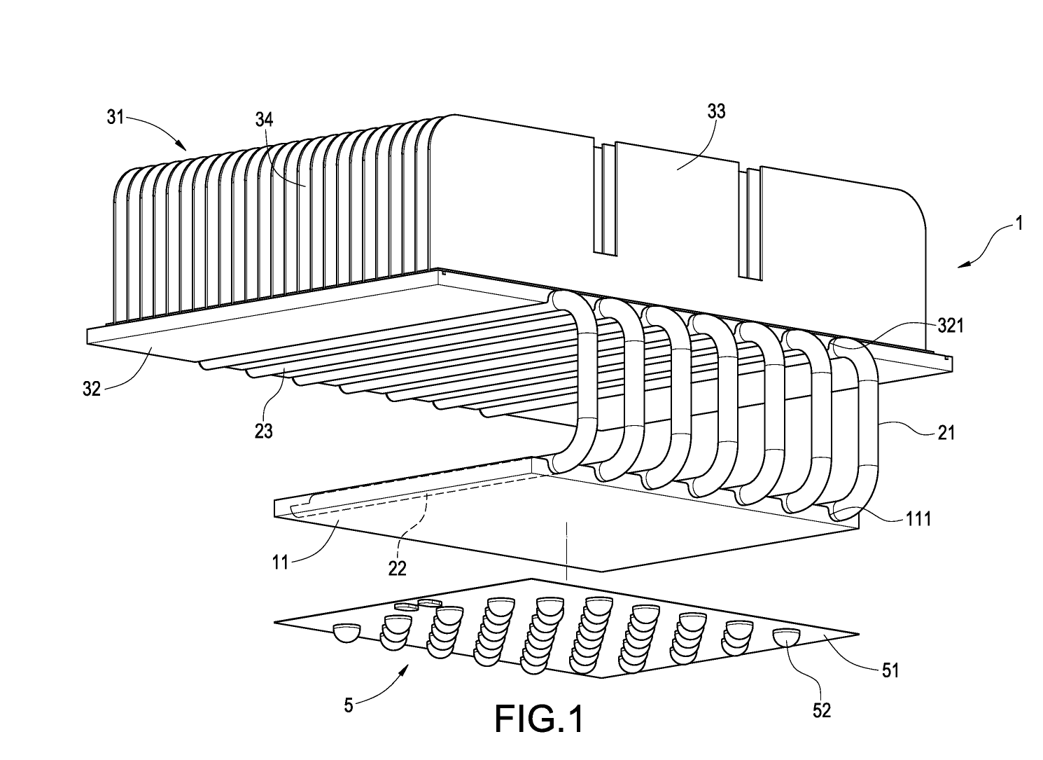

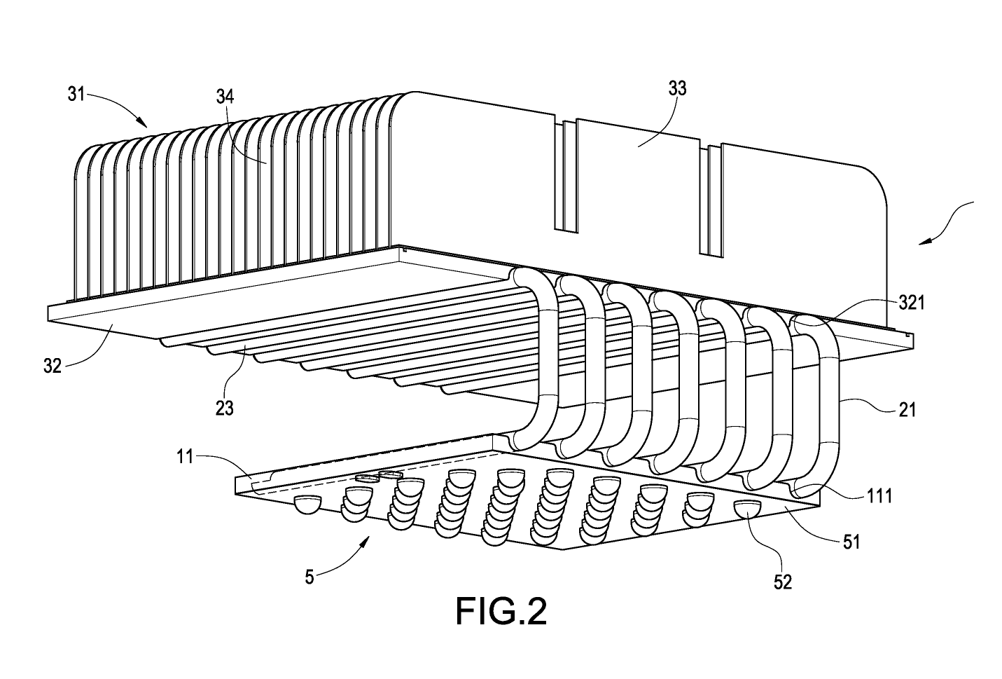

Referring to FIGS. 1 and 2, an isometric exploded view and an isometric assembled view of a heat sink and a LED light module in accordance with an exemplary embodiment of the present invention, are provided. The present invention relates to an illumination device having an unidirectional heat-dissipating route. The illumination device mainly includes a heat sink 1 and a LED light module 5.

The heat sink 1 includes a heat plate 11, one or at least one heat pipe 21 and a heat dissipating body 31. The heat plate 11 is made of aluminum, copper or other material with high heat-conducting capability. A plurality of grooves 111 are formed in a top surface of the heat plate 11, and the grooves 111 are parallel to each other.

The amount of the heat pipe 21 may be changed according to the heat generated in fact. In this exemplary embodiment, the illumination device includes seven heat pipes 21, and each heat pipe is U-shaped. Each heat pipe has a high portion and a low portion parallel to the high portion, which are served as a heat absorbing portion 22 and a heat dissipating portion 23 of the heat pipe 21 respectively. The heat absorbing portion 22 and the heat dissipating portion 23 are not arranged in a same horizontal position, and the heat absorbing portion 22 is below the heat dissipating portion 23. In this exemplary embodiment, the cross-section of the heat absorbing portion 22 is round, and a part thereof is embedded into the corresponding groove 111 of the heat plate 11 to increase the contact surface therebetween. Furthermore, heat-conducting interface (not shown) may be spread on the contact surface to improve the sealed result between the heat plate 11 and the heat pipe 21. It should be noted that although the heat dissipating portion 23 is parallel to the heat absorbing portion 22 in this exemplary embodiment, it is obvious for persons skilled in the art that a slightly-risen angle may be defined between the heat dissipating portion 23 and the heat absorbing portion to perform the present invention.

The heat dissipating body 31 is composed of a heat-conducting substrate 32 and a plurality of cooling fins 33 arranged on the heat-conducting substrate 32. The heat-conducting substrate 32 is made of aluminum, copper or other material with high-conducting capability. Furthermore, a plurality of parallel grooves 321 are formed on a bottom surface of the heat-conducting substrate 32, and the grooves 321 are configured for receiving the heat dissipating portion 23 of the heat pipe 21. Similarly, heat-conducting interface (not shown) may be spread on a contact surface between the heat dissipating portion 23 and the grooves 321. The cooling fins 33 are made of aluminum, copper or other material with high heat-conducting capability, and inserted into the heat-conducting substrate 32 at regular intervals. A heat-dissipating route 34 is defined between every two adjacent cooling fins 33.

The LED light module 5 includes a base plate 51 having a bottom surface and an opposite top surface, and a plurality of LEDs 52 attached on the bottom surface of the base plate 51. The top surface of the base plate 51 is configured for being attached to the bottom surface of the heat plate 11.

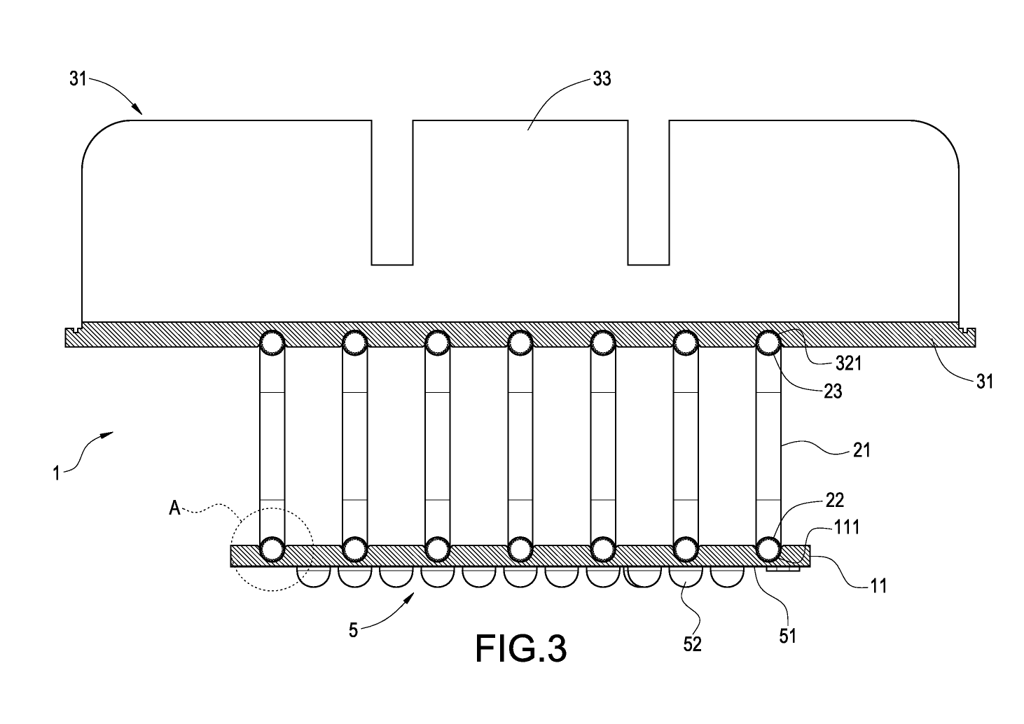

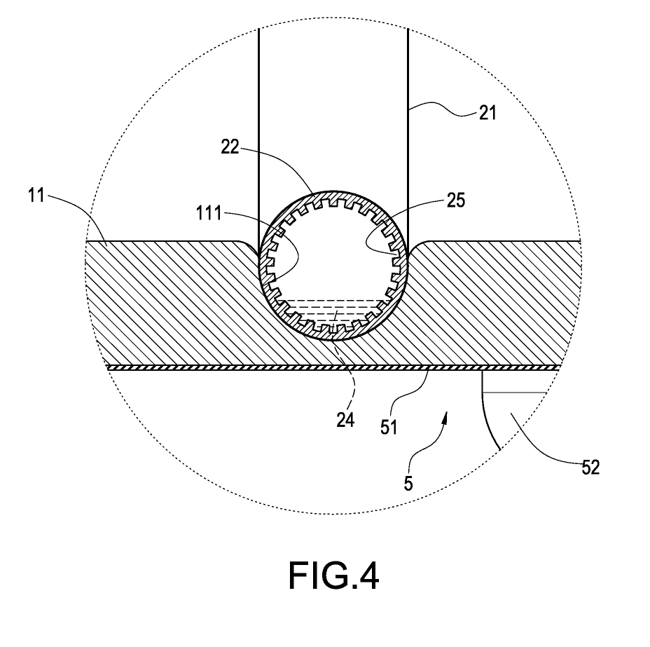

Referring to FIGS. 3 and 4, an assembled cross-sectional view and a partial-enlarged view of region A as shown in FIG. 3 of the illumination device of the present invention, are provided. The heat pipe 21 has working fluid 24 filled therein and a plurality of continuous grooves 25 communicated with the heat absorbing portion 22 and heat dissipating portion 23. The continuous grooves 25 are parallel to the axis line of the heat pipe 21, and a vacuum chamber is defined in the heat pipe 21. The heat pipe 21 transmits the heat by the change between the vapor state and the liquid state, such that the heat-conducting speed thereof is greatly larger than that of the solid.

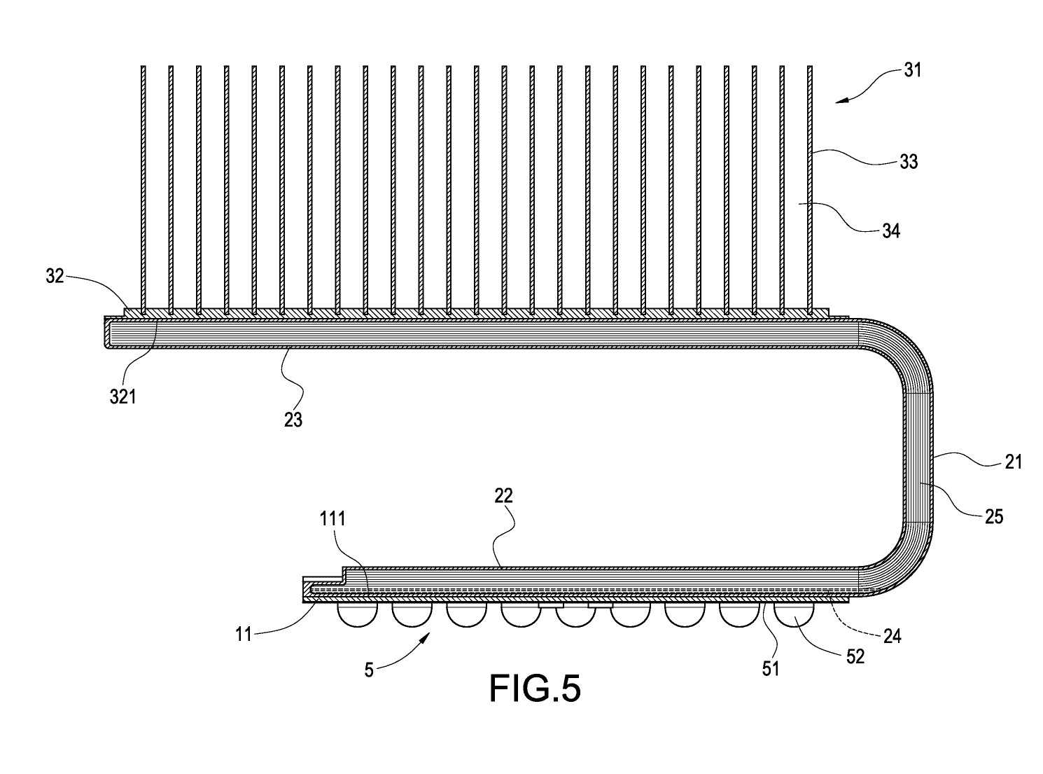

Referring to FIG. 5, a using-state cross-sectional view of the illumination device of the present invention, is provided. The present LED illumination device may be used in outdoor. The LED light module 5 is driven in the night such that the LEDs 52 emit light. The heat generated from the LEDs 52 is transmitted to the heat plate 11 and the low heat absorbing portion 22 of the heat pipe 21 in series. Thus the working fluid in the heat pipe 21 is heated to be vaporized. The vaporized vapor carrying a great deal of heat flows rapidly to the high heat dissipating portion 23 of the heat pipe 21, and then the heat is transmitted to the heat-conducting substrate 32 and the cooling fins 33 of the heat-dissipating body 31. Finally the heat is dissipated from the cooling fins 33 to the outer environment. Furthermore, the cooling fins 33 and the heat-conducting substrate 32 dissipate continuously the heat of the heat dissipating portion 23 of the heat pipe 21, such that the vaporized vapor in the heat dissipating portion 23 is cooled to be liquid, and the cooled liquid reflows into the low heat absorbing portion 22 of the heat pipe 21 through the continuous grooves 25 by the gravity and the continuous grooves 25. Thus a heat-exchanging cycle is finished, and a heat-dissipating route is represented.

Contrarily, the LED light module 5 is closed in the day. The cooling fins 33 are irradiated directly or indirectly by the sunlight such that the cooling fins 33 will receive the heat. The heat is transmitted only to the high heat dissipating portion 23 of the heat pipe 21. Since the working fluid 24 of the heat absorbing portion 22 is resulted by the gravity, and the heat absorbing portion 22 of the heat pipe 21 is lower than the heat dissipating portion 23 thereof, the heat of the heat dissipating portion 23 of the heat pipe 21 cannot be transmitted to the low heat absorbing portion 22 of the heat pipe 21. Thus the inversed heat-dissipating route is open, and the LEDs 52 are protected and prevented from being destroyed by the heat. The working life of the LEDs 52 is increased greatly.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An illumination device having an unidirectional heat-dissipating route, comprising:
a heat sink, the heat sink comprising:
a heat plate;
a heat pipe having a heat absorbing portion and a heat dissipating portion with a horizontal position different to that of the heat absorbing portion, the heat absorbing portion being connected to the heat plate, a plurality of grooves being formed in the heat pipe to be communicated with the heat absorbing portion and the heat dissipating portion, the heat absorbing portion being lower than the heat dissipating portion; and
a heat-dissipating body connected to the heat dissipating portion; and
a LED light module connected to the heat plate.

2. The illumination device as claimed in claim 1, wherein the grooves are parallel to an axis line of the heat pipe.

3. The illumination device as claimed in claim 1, wherein the heat pipe has a top surface, a plurality of grooves are formed in the top surface of the heat pipe, and the heat absorbing portion is embedded in the grooves.

4. The illumination device as claimed in claim 1, wherein the heat pipe is U-shaped.

5. The illumination device as claimed in claim 4, wherein the heat absorbing portion is parallel to the heat dissipating portion.

6. The illumination device as claimed in claim 1, wherein the heat-dissipating body comprises a heat-dissipating substrate and a plurality of cooling fins.

7. The illumination device as claimed in claim 6, wherein the heat-dissipating substrate has a bottom surface, and a plurality of grooves are formed in the bottom surface thereof and are configured for receiving the heat dissipating portion.

8. The illumination device as claimed in claim 1, wherein the LED light module comprises a base plate and a plurality of LEDs attached on the base plate, the base plate has a top surface and the heat plate further has a bottom surface opposite to the top surface of the heat plate, and the top surface is attached to the bottom surface of the heat plate.

9. The illumination device as claimed in claim 1, wherein a slightly-risen angle is defined between the heat dissipating portion and the heat absorbing portion.
